(19) United States
(12) Patent Application Publication
(10) Pub. No.: US 2024/0169369 A1
(43) Pub. Date: May 23, 2024

(54) System and Method of authenticating Physical goods Cryptographically

(71) Applicants: Jacob Elmon, London (GB); Brandon Elmon, London (GB)

(72) Inventors: Jacob Elmon, London (GB); Brandon Elmon, London (GB)

(21) Appl. No.: 18/513,709

(22) Filed: Nov. 20, 2023

Related U.S. Application Data
(60) Provisional application No. 63/427,572, filed on Nov. 23, 2022.

(51) Int. Cl. G06Q 30/018; G06T 11/00

(52) U.S. Cl. CPC G06Q 30/0185; G06T 11/00; G06T 2210/16

(57) ABSTRACT

This invention presents a method for verifying the authenticity of garments by using Smart Tags connected to distinct NFTs within a blockchain framework. A unique NFT associated with the physical garment is verified with block chain. The process involves the integration of smart tags attached in the physical garment with Non-Fungible Tokens (NFTs) and the incorporation of Augmented Reality (AR) or hyper-reality elements to enrich user experiences and foster multi-user interactions. These tags are strategically placed within the clothing and are equipped with unique identification data for each garment.

### CROSS REFERENCE TO RELATED APPLICATIONS

The present application derives priority from US Provisional patent application No. U.S. 63/427,572 filed on 23 Nov. 2022 and incorporated herein for reference.

### FIELD OF INVENTION

The present invention relates to authentication of Augmented reality enabled garments in association with Block chain and Non-Fungible Tokens. More specifically the invention uses a smart tag integrated with Non-Fungible Tokens (NFT) and associated Augmented reality or hyper reality to enhance user experiences and enable multi user interactions.

### BACKGROUND OF THE RELATED ART

Digitalization of physical goods is a rapidly evolving field that gives the users an immersive experience through Augmented and Hyper reality experiences. Augmented Reality (AR) stands as an emerging frontier, seamlessly blending the virtual with the real world. This immersive technology incorporates multimedia, 3D modeling, real-time tracking, and sensing capabilities to empower users in recreating and enhancing their physical surroundings. Alongside AR, the Non-Fungible Tokens (NFTs) has brought digital assets to the forefront.

The use of smart tags, preferably an RFID (Radio Frequency Identification) or NFC (Near Field Communication) tag, in conjunction with physical products like garments can enhance the functionality and interactivity of the garments, allowing for new types of experiences and applications. Non-Fungible Tokens (NFT), built on blockchain technology, provide a way to establish ownership and uniqueness for digital assets, which cannot be replicated and copied as it is unique, valuable and unchangeable in nature. This digitization of physical goods has witnessed remarkable advancements, enabling users to enjoy hyper-reality experiences. Digital assets may be made available from companies through their various networking platforms including digital games, social media systems, membership/customer engagement programs or online stores.

The present invention brings together AR, block chain, NFT and Smart Tag together for scanning and authenticating the clothing item by viewing the garment.

### DESCRIPTION OF THE RELATED ARTS

NFC Tags linked to unique NFTs offer an innovative method for authenticating and confirming ownership of physical goods. The NFT has the description in the metadata which is digitally authenticated with the product. It can trace the details of creators/owners and the published dates recorded on a block chain.

U.S. Ser. No. 10/505,726B1 teaches about the cryptographic digital asset that includes a digital shoe and a unique digital shoe ID code. The middleware server computer links the cryptographic digital asset with the unique owner ID code, and records the unique digital shoe ID code and the unique owner ID code on a transaction block with a distributed block chain ledger.

The granted patent U.S. Ser. No. 10/607,411B1 reveals a method of augmenting reality of a physical garment, comprising the receiving of a demand from a user by a receptor to create an augmented garment from information about the physical garment and about a digital component to be linked to the physical garment. The information is organized according to at least one classification by the receptor, which sends the information to a production tracker for garment process distribution. The information is tested to ensure the digital component is functioning properly and is compatible with the physical garment. The physical garment is manufactured, and then blended with the digital component into the augmented garment, and finally delivered to the user.

The granted patent U.S. Pat. No. 9,858,724B2 teaches an augmented reality design system that allows a user to create a design for an article in real time using a proxy. The system can be configured using a head mounted display for displaying at least one virtual design element over a proxy located in a real-world environment. The system can also be configured using a projector that projects at least one virtual design element onto a proxy located in the real world.

WO2019168780 introduces augmented reality (AR) experiences associated with wireless tags. These AR experiences are enriched with enhanced data related to various objects or commercial products like wine bottles, medicine jars, or clothing. Users can access these AR experiences on their mobile devices, particularly smartphones, via a graphical interface. This computer-implemented method enables the creation of augmented reality (AR) experiences for physical articles on portable computing devices. It involves associating physical articles with AR metadata, stored on a cloud computing system accessible via a network. An AR application on the device is activated after user verification. Users can trigger AR experiences by tapping wireless tags on physical articles, utilizing near-field communication (NFC) for data exchange.

U.S. Pat. No. 11,546,441 B2 describe systems and methods aim to enhance user experiences with physical items by blending them with digital content. Users employ electronic devices to scan smart tags linked to items, retrieving item identifiers. These identifiers are then sent to a server, which selects relevant digital content related to the item and sends it back to the user's device for display. The method performed on a mobile device involves users providing their account information through an interface. The system determines whether the user is registered or unregistered based on this information. If registered, the user receives various digital content options related to the item through a smart tag reader.

U.S. patent Ser. No. 11/308,184B2 integrates cryptographically secured digital assets into video games by utilizing a digital asset ID code securely stored on a blockchain along with a unique owner ID code. The digital asset ID code contains subsets representing asset attributes and is provided to a virtual object generator, which creates virtual objects with various attributes. Importantly, these object attributes can modify character attributes in the game. This innovation can connect physical products like shoes to virtual collectibles. When a consumer buys a physical item, a digital representation linked to them is generated, secured on the blockchain, and can be traded, stored in cryptocurrency wallets, or used to create new virtual items.

U.S. patent Ser. No. 11/308,184B2 presents a method for integrating cryptographically secured digital assets into digital video games. It involves receiving a secure digital asset ID code stored on a blockchain ledger, along with a unique owner ID code, representing attributes of the digital asset. Using this code, a virtual object generator creates a virtual object with various attributes, which can modify character attributes in the game. This innovation is practical for linking physical products like shoes to virtual collectibles. Tangible purchases result in digital representations securely stored on the blockchain, enabling secure trading, cryptocurrency wallet storage, and the creation of new virtual items.

The related art lacks provisions for effectively authenticating a physical garment or digital garment using an augmented reality system.

### SUMMARY OF THE INVENTION

The disclosed invention pertains to the authentication process of garments using a smart tag associated with NFTs and aims to enhance the user experience of physical garments by providing augmented or hyper-reality experiences linked to the garments. The preferred tag in this context is an RFID (Radio Frequency Identification) or NFC (Near Field Communication) tag, but it is not limited to these technologies and can encompass other communication technologies or advanced chips. These tags are equipped with unique identification data for each garment and are designed to withstand flexing, domestic washing, and drying cycles. They are strategically placed within the clothing, playing a pivotal role in the system's functionality. The primary purpose of these tags is to identify the type and authenticity of the garment.

In one aspect of the invention, it describes a system for monitoring the authenticity of garments by associating physical garments with smart tags and NFTs, which can be authenticated using a smartphone or AR glasses or other compatible devices. These tags establish a direct link between the physical garment and its corresponding NFT. The NFC tag verifies both the authenticity of the physical garment and its digital counterpart, ensuring that users interact with genuine products.

Another aspect of the present invention involves users scanning the smart tags, which then launch a software application or URL. Additionally, data sharing between phones using NFC (peer-to-peer (P2P) communication) is facilitated. A dedicated mobile application is a crucial component of this system, requiring users to install it on their smartphones or wearable devices, such as smart glasses. The mobile application plays a central role in coordinating interactions and rendering digital garments in augmented reality. After confirming the garment's authenticity, the smartphone can display the digital garments related to the physical clothing. These digital garments are seamlessly overlaid onto the wearer's physical attire.

In yet another aspect, a software application serves as a linking platform between physical clothing and real-world gaming experiences. It facilitates rewards, leaderboards, and social interactions among players. The system may employ a points system, where users accumulate points by scanning real individuals wearing the clothing or by interacting with digital avatars in a virtual environment. Users can earn points, which are then displayed on a leaderboard and can be redeemed for physical clothing or digital clothing (NFTs) through official retailers.

In another aspect of the present invention, the physical clothing generates a hyper-reality field (an electromagnetic field) through the tag when associated with a power source. A power source is essential for the hyper-reality field, which can be either a rechargeable battery or a flexible, energy-efficient chip integrated into the fabric. This field, when viewed through compatible augmented reality (AR) devices such as AR headsets, enables users to experience the augmented environment, effectively creating a localized augmented reality environment.

### BRIEF DESCRIPTION OF THE ACCOMPANYING DRAWINGS

FIG. 1 illustrates a diagram for authenticating physical garment with a block chain network through a mobile application and an NFC tag attached to the physical garment.

FIG. 2 is a diagram illustrating the parts of the NFC Tag.

FIG. 3 illustrates data flow between NFC enabled device and the NFC Tag.

FIG. 4 illustrates the various components of the Garment NFC tag management system

FIG. 5 illustrates an example flow diagram of a user scanning the garment tag for authentication and multiple interactions with other users.

FIG. 6 illustrates flowchart of the system of linking and verifying a physical garment to a block chain network.

Other aspects of the present invention shall be described in further detail of the next section.

### DESCRIPTION OF THE PREFERRED EMBODIMENT

The embodiments herein and the various features and advantageous details thereof are explained regarding the non-limiting examples in the following description. The examples used herein is intended merely to facilitate an understanding of how the embodiments herein may be practiced and to further enable those of skill in the art to practice the embodiments herein.

Unless otherwise defined, all terms (including technical and scientific terms) used herein have the same meaning as commonly understood by one of the ordinary skills in the art of this disclosure. It will be further understood that terms, such as those defined in commonly used dictionaries, should be interpreted as having a consistent meaning in the context of the specification and should not be interpreted in an idealized or overly formal sense unless expressly so defined herein. Well-known functions or constructions may not be described in detail for brevity or clarity.

The present invention discloses authenticating garments through smart tags and NFTs while enriching the user's experience by integrating augmented or hyper-reality elements with physical clothing. The preferred tags, including RFID or NFC or other advanced chips, are strategically placed within garments to withstand wear and washing. These tags link physical garments to corresponding NFTs, allowing users to verify authenticity using smartphones or AR glasses or other compatible devices. A dedicated software or mobile application coordinates interactions, enabling users to scan tags and instantly access augmented reality content related to their clothing. Additionally, the system fosters social interaction, rewards, and gaming experiences, and it can generate a localized augmented reality environment when powered by a rechargeable battery or energy-efficient fabric-integrated chip, viewed through compatible AR devices. 1. The Augmented Reality content associated with the physical garment involve virtual elements overlaid on the physical garment when viewed through AR enabled devices. The virtual element may include but not limited to garment details including designer name, material used, color options, virtual try ons and stylig tips.

In the present embodiment NFC technology is used in the context of NFTs, for example, to authenticate physical items connected to digital NFTs. NFC garment provides a means of physical interaction and verification, while NFTs are a digital asset representation on a blockchain NFC (Near Field Communication) chips or tags can be embedded in garments for various purposes, such as tracking inventory, authenticating products, or providing interactive experiences for customers. NFC tags on garments work by using Near Field Communication technology, which allows for short-range wireless communication between the NFC tag and an NFC-enabled device (like a smartphone or tablet). A small NFC tag is integrated into or attached to the garment. This tag contains a microchip and an antenna. It can be sewn into a discreet pocket, embedded in a label, or affixed to the fabric. When a customer or user taps their NFC-enabled device (e.g., smartphone) near the NFC tag on the garment, it activates the NFC communication. The NFC tag transmits data to the NFC-enabled device. This data can include information about the garment, such as product details, sizing, pricing, care instructions, and links to related digital content.

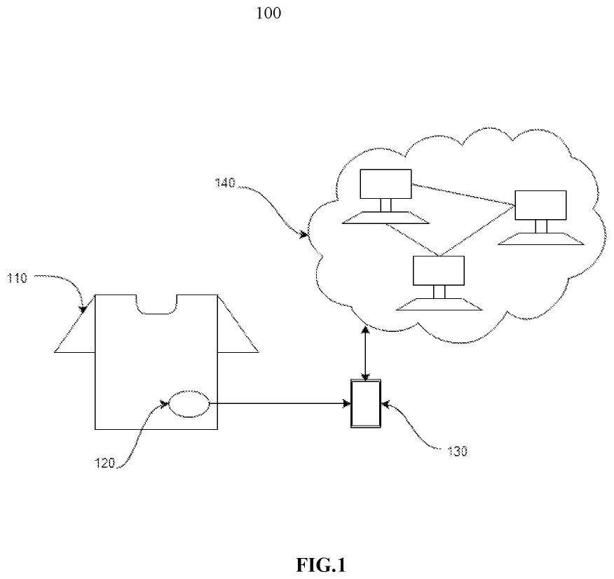

FIG. 1 illustrates the garment augmented reality system 100. System 100 may include a physical garment 110 of any kind of material. Examples of such materials include synthetic garment, woolen garment, cotton garment as well as other types of physical garments 110. System 100 include provisions for displaying an augmented reality image or video to a user through a smart phone 130 or any other compatible AR device. When a user's AR device or smart phone is brought close to the tag on the garment, it triggers an interaction which include reading data from the tag to identify the garment. System 100 include authentication of physical garment using block chain network. When the tag is scanned by a compatible AR device, it verifies the authenticity of the garment and its digital counterpart, ensuring users are interacting with genuine products. When users scan the NFC tag, it will launch a software application or URL. Users would need a dedicated mobile application installed on their smartphones or wearables (e.g., smart glasses). The user's device can display information, images, videos, or links associated with the garment. This enhances the user's shopping experience by providing additional product information, styling suggestions, or even the option to purchase the item online. The software application manages the AR experiences and provides a user-friendly interface for selecting and launching different AR content options or even interactive games related to the garment. The application can overlay digital information or interactive elements onto the real world, creating a hyper real experience. NFC can enhance interactivity within a hyper-reality experience. It can be used to change digital content or interactions based on the physical objects the user interacts with. For instance, in a clothing store, tapping an NFC tag on garment might provide additional information on the clothing i.e., manufacture date size, design, cost, pattern etc

The tag 120 and smart phone 130 communicate with the computing system 140 using any type of wireless/or wired connection which are not limited to personal Area network, wide area network, local area network and Bluetooth. The augmented reality metadata associated with the physical article is then securely stored on the server computing system 140. This server system allows users to retrieve and interact with the augmented reality content associated with the physical garment. The software application is supported by this robust backend infrastructure for data storage and management, including user profiles, garment information, and content libraries.

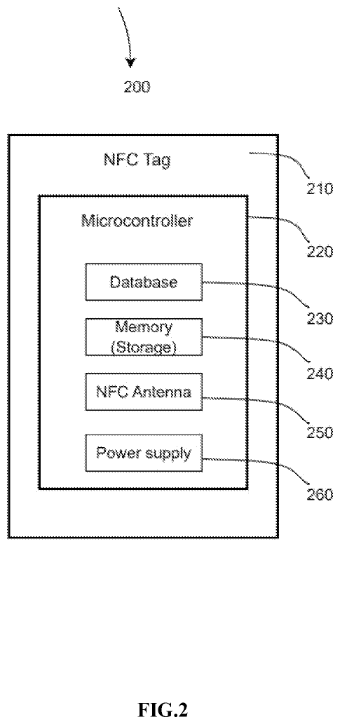

In FIG. 2 the NFC Tag 210 is depicted as a rectangular shape. Inside the NFC Tag, the Microcontroller 220 plays a crucial role. It controls the operation of the NFC tag. The connection between the Microcontroller and Memory components is symbolized as the Database 230. This connection enables Microcontroller to access and manage data within the Memory. The Memory (Storage) 240 represents the storage component within the NFC tag where data, such as URLs or other information, is stored. The NFC Antenna 250 is a critical component for communication. It connects to the NFC communication circuitry and is often a coil or printed trace on the NFC tag's substrate. The NFC tag may have a power supply circuit 260, which can include a rectifier for harvesting energy from the RF (radio frequency) field of the NFC reader. This circuit provides power to the microcontroller and other components

NFC tags can also be used for interactive experiences, such as enabling customers to access exclusive content, join loyalty programs, or participate in marketing campaigns related to the brand or product. NFC tags can be equipped with security features to prevent counterfeiting or tampering, ensuring the authenticity of the garment. Overall, NFC tags on garments enhance the retail experience by providing convenient access to information and interactive content, helping customers make informed decisions and engage more deeply with brands and products.

NFC Tags linked to unique NFTs offer an innovative method for authenticating and confirming ownership of physical goods. When users tap an NFC-enabled device onto the tag, they gain access to the NFT's metadata, which contains valuable details and the AR meta data of the products. This fusion of blockchain technology with NFTs ensures the asset's authenticity, and the use of NFC tags makes it a seamless and user-friendly experience. NFC enabled garment provides a means of physical interaction and verification, while NFTs are a digital asset representation on a blockchain. NFC tag garments can enhance hyper-reality experiences by enabling interactions between physical clothing items and digital content. Users can tap their smartphone to an NFC-enabled garment to access virtual try-on experiences, view product information, or unlock exclusive digital content related to the clothing. This technology blurs the lines between the physical and digital worlds, creating immersive and engaging experiences for consumers.

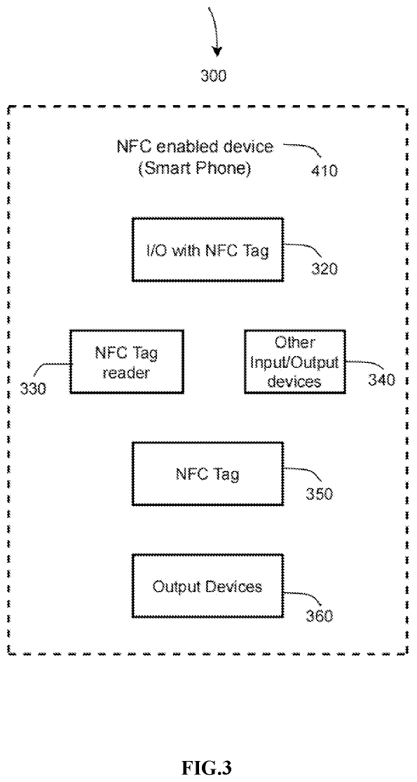

The FIG. 3 illustrates the flow of data from the NFC tag to the NFC Reader (sensor) and then to the output devices. The specific functionality and interactions depend on the application and purpose of the NFC. The NFC Enabled device 310 represents a device, such as a smartphone or tablet, equipped with NFC capabilities. Within the NFC enabled device, there is an Input/Output (I/O) diagram with NFC Tag 320, which represents the interaction between various components. The NFC Reader (sensor) 330 is depicted as a component that reads data from the NFC tag 350. Other input/output devices 340 within the system could be a supplementary input device or an additional output device that interacts with the NFC-enabled device and NFC tag. When the NFC-enabled device (410) is brought near the NFC Tag, the reader (sensor) initiates communication and retrieves data from the tag. The NFC Tag 450 is the NFC-enabled tag or object that stores data. NFC tags are passive devices, meaning they do not require their own power source. Instead, they draw power from the NFC reader's electromagnetic field when they are within close proximity. NFC tags can store various types of information, including URLs or unique NFT for the digital garment. Output Devices 460 represent components that receive data from the NFC Reader on the NFC Tag, such as a display, speakers or any other devices that may interact with the data.

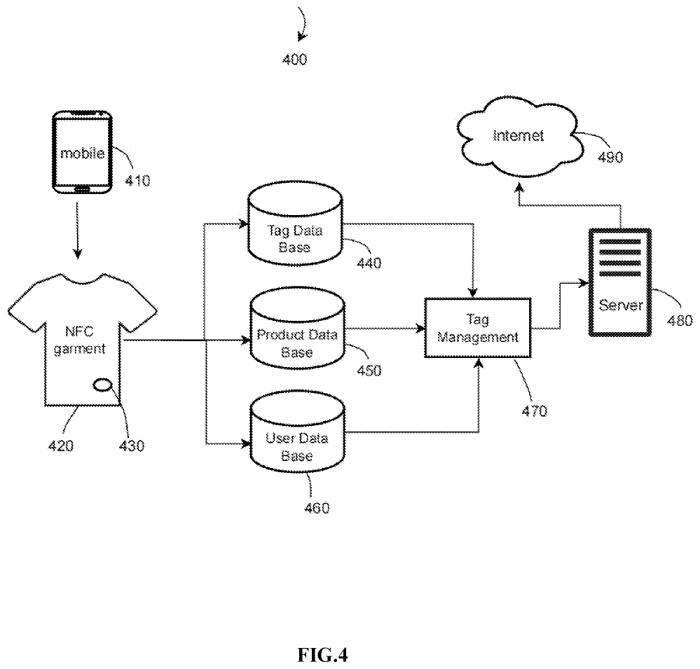

The various components of the Garment NFC tag management system are illustrated in FIG. 4. The user's smartphone 410 interacts with NFC garments as a bridge between the physical NFC tag on the garment and the digital information stored in databases. The physical garment 420 contains an embedded NFC tag 430. This NFC tag verifies the authenticity of the garment and its digital counterpart, ensuring users are interacting with genuine products and also serves as a key to access digital information associated with the garment. There is a central Tag Database 440 that stores information about all NFC tags used in garments. Each tag is associated with specific details, such as product information, authenticity records, and other metadata. The Product Database 450 stores information about the garments. It includes details about the garments, such as their type, designer, brand, style, and any other relevant product data. The User Database 460 holds information about users who owns the NFC. It includes user profiles, preferences, and interaction history. Tag Management module 470 is responsible for assigning specific NFC tag IDs to individual garments. It ensures that each NFC smart tag and associated NFT is correctly linked to the corresponding product. The server 480 acts as the central component that facilitates communication between the databases, the tag management module, and users' smartphones. It manages requests from smartphones to access information associated with NFC garments. The internet 490 connects all these components, enabling real-time communication and data exchange. When a user taps their smartphone on an NFC garment, it sends a request over the internet to the server, which then retrieves the relevant information from the databases.

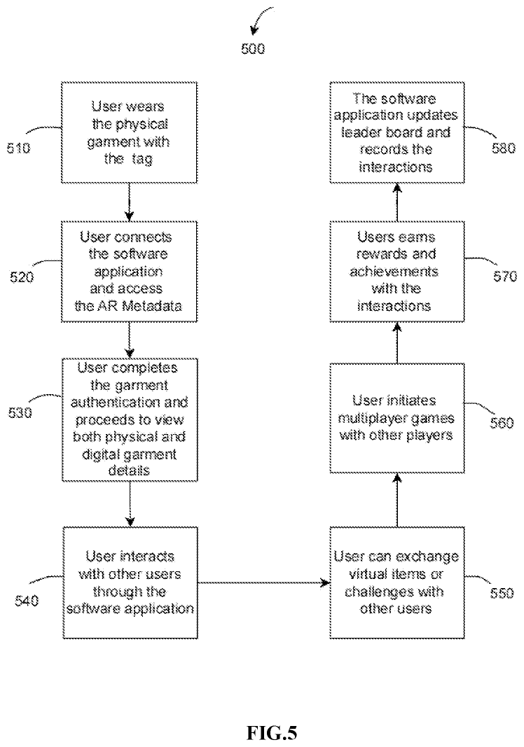

FIG. 5 depicts a flow diagram 500, where user interacts with other users wearing the NFC garment. In step 510, a user may wear the garment and as in step 520 can connect it to the dedicated software application on a smartphone by the scanning the tag. When a user's mobile device or wearable is brought close to the NFC tag on the garment, it triggers an interaction. This could include reading data from the NFC tag to identify the garment. The application recognizes the NFC tags on the garment and associate them with the corresponding digital content. At step 530, the user completes the authentication of the physical garment and proceeds to access the AR metadata of the physical garment. The NFC tag verifies the authenticity of the garment and its digital counterpart, ensuring users are interacting with genuine products. The software application can display various types of content, such as images, videos, product information, or even interactive games related to the garment. The users can start interacting with each other through the software application as in step 540. The application interface may present the scanned user's profile or virtual representation, allowing the user to interact with it in various ways. At step 550, user can exchange virtual items, experiences, or challenges with the other users. Through the software application, users can initiate multiplayer games or competitions as in step 560, further enhancing the overall interactive experience. Users can also earn rewards and achievements during the multiplayer interactions at step 370. At 380 the application server records the interactions and data exchanged with the scanned user, enabling the accumulation of rewards, achievements, and progress tracking.

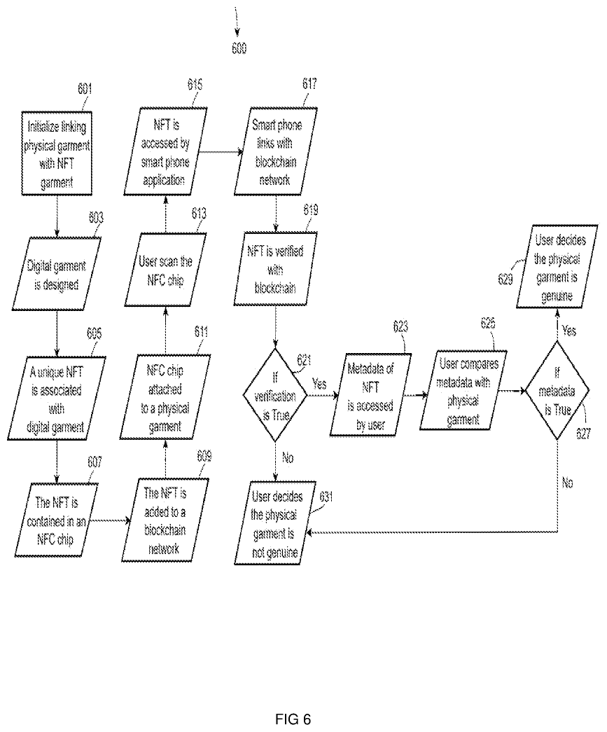

FIG. 6 illustrates the linking and verifying of a physical garment to a block chain network. During step 601, a user may initialize linking physical garment with NFT garment. In step 603, user may design a digital garment and in step 605 a unique NFT is associated with digital garment. Step 607 mention about the presence of NFT in an NFC chip. In step 609, the NFC is added to a block chain network. During step 611, the NFC chip is attached to a physical garment. In step 613, the user scans the NFC chip. During step 615, NFT is accessed by a smart phone application. In step 617, the smart phone is linked with a block chain network. In step 619, NFT is verified with block chain network. During step 621, the user verifies the data. If the user verifies the data and found it as true then according to step 623, the user can access the metadata of NFT. If the user verifies the data and found it as false then the user according to step 631, decides the physical garment is not genuine. In step 625, the user compares the metadata with physical garment. Step 627 verifies if the metadata is true or not. If it is found true then according to step 629, user decides the physical garment is genuine. If it is found false then according to step 631, the user decides the physical garment is not genuine.

NFC chip garments can enhance hyper-reality experiences by enabling interactions between physical clothing items and digital content. Hyperreality experiences often involve technologies like augmented reality (AR) or virtual reality (VR), which use sensors, cameras, and displays to create immersive digital environments. Users can tap their smartphone to an NFC-enabled garment to access virtual try-on experiences, view product information, or unlock exclusive digital content related to the clothing. This technology blurs the lines between the physical and digital worlds, creating immersive and engaging experiences for consumers.

One remarkable application of NFC-enabled garments is the immersive try-on experiences they offer. Users with NFC-enabled smartphones or devices can approach the garment. By tapping their NFC-enabled device to a specific area on the garment, the NFC chip is activated. After activation, users may be directed to a mobile application or website that offers a virtual try-on experience. This can include seeing how the garment looks on a virtual avatar or superimposing it on a live camera feed of the user. Users may also receive information about the garment, such as sizing, pricing, and availability. They can potentially customize the garment virtually, changing colors or styles. If the user likes the garment, they can proceed to purchase it through the app or save it for future reference. This NFC-enabled try-on experience bridges the gap between physical shopping and the digital world, providing customers with a convenient and interactive way to explore fashion items.

What is claimed is:

1. A method of authenticating physical goods cryptographically comprising:
a) embedding a smart tag on the physical garment associated with a unique Non-Fungible Token (NFT);
b) the smart tag generating a hyper-reality field through a power source, creating a localized augmented reality environment when viewed through compatible augmented reality devices;
c) a dedicated mobile application for users to install on their smartphones or wearable devices for facilitating interactions with the smart tags;
d) the smart tag when scanned by the said mobile application verifies the associated NFT on the blockchain network and provides access to augmented reality content associated with the said garment.

2. A method according to claim 1, wherein the smart tag is a Radio Frequency Identification (RFID) tag or a Near Field Communication (NFC) tag.

3. A method according to claim 1, wherein the tag is strategically placed within the physical garment and can withstand wear and tear, domestic washing, and drying cycles.

4. A method according to claim 3, wherein the tag generates a hyper-reality field around the user, thus creating a localized augmented reality environment when viewed through compatible augmented reality devices.

5. A method according to claim 1, wherein a dedicated mobile application enables users to exchange virtual items, experiences, and challenges, fostering social interactions and gaming experiences among users.

6. A method according to claim 1, wherein the smart tag when scanned by the dedicated mobile application verifies the associated NFT on the blockchain network and additionally provides access to augmented reality content associated with the physical garment.

7. A method according to claim 5, wherein the users earn points through interactions and gaming activities on the mobile application, the earned points are displayed on leader boards and can be redeemed for any physical or virtual clothing through official retailers.

8. A method according to claim 6, wherein the mobile application may connect with augmented reality (AR) devices, such as AR headsets or glasses, to view and interact with the augmented reality content.

9. A method according to claim 6, wherein the Augmented Reality content associated with the physical garment involve virtual elements overlaid on the physical garment when viewed through AR enabled devices.

10. A method according to claim 9, wherein the virtual element may include but not limited to garment details including designer name, material used, color options, virtual try ons and stylig tips.

11. A system for intelligent garment tagging comprising:
a. a server, a computing device connected to the server;
b. a database configured to store information related to garment specification, ownership details, transaction history; Augmented Reality meta data, smart tags and NFTs (Non Fungible Tokens);
c. a communication interface facilitating communication between the server and computing device.
d. a dedicated mobile application for users to install on their smartphones or wearable devices for facilitating interactions with the smart tags.

12. A system according to claim 11, wherein the smart tags are embedded on the physical garments and the smart tags generate a hyper-reality field around the user, thus creating a localized augmented reality environment when viewed through compatible augmented reality devices.

13. A system according to claim 12, wherein the smart tag is a Radio Frequency Identification (RFID) tag or a Near Field Communication (NFC) tag.

14. A system according to claim 11, wherein a dedicated mobile application facilitates interaction with the smart tags; the smart tags when scanned by the said mobile application verifies the physical garment associated NFT on the blockchain network and provides access to augmented reality content associated with the said garment.

15. A system according to claim 14, wherein the Augmented Reality content associated with the physical garment involve virtual elements overlaid on the physical garment when viewed through AR enabled devices.

16. A system according to claim 15, wherein the virtual element may include but not limited to garment details including designer name, material used, color options, virtual try ons and stylig tips.

17. A system according to claim 15, wherein the augmented reality (AR) devices include but not limited to AR headsets or glasses, to view and interact with the augmented reality content.
